(19) United States
(12) Patent Application Publication
(10) Pub. No.: US 2013/0081643 A1
(43) Pub. Date: Apr. 4, 2013

(54) Composite Additive Materials

(71) Applicants: Peter Branton, London (GB); Michele Mola, London (GB)

(72) Inventors: Peter Branton, London (GB); Michele Mola, London (GB)

(73) Assignee: BRITISH AMERICAN TOBACCO (INVESTMENTS) LIMITED, London (GB)

(21) Appl. No.: 13/638,896

(22) PCT Filed: Mar. 31, 2011
(86) PCT No.: PCT/GB2011/050658

§ 371 Date: Dec. 17, 2012

(30) Foreign Application Priority Data
Apr. 1, 2010 (GB) 1005547.3

(51) Int. Cl. A24D 3/12; B01J 39/20

(52) U.S. Cl. CPC A24D 3/12; B01J 39/20
USPC 131/332; 521/31; 521/29

(57) ABSTRACT

The invention relates to composite materials comprising particles of at least two different additive materials and a polymer binding said additive particles together the composite material. The invention also relates to incorporating at least two different additive materials into a filter material, using the composite material.

The present invention relates to aggregated or agglomerated additives for inclusion in the filters of smoking articles. More specifically, it relates to aggregates or agglomerates comprising at least two filter additives and a polymer. The invention also relates to the agglomeration of granular additive materials and powders using a polymer as a binding agent, as well as to the use of such agglomerates.

### BACKGROUND

It is known to include additives in the filters of smoking articles for a variety of purposes. Many of these additives are particulate in form.

For example, it is well known to incorporate porous carbon materials in smoking articles and smoke filters in order to reduce the level of certain materials in the smoke. Porous carbon materials may be produced in many different ways, including by activation processes. The physical properties of porous carbon materials, including the shape and size of particles, the size distribution of the particles in a sample, the attrition rate of the particles, the pore size, the distribution of pore size and the surface area, all vary widely according to the manner in which they have been produced and the nature of the starting material used. These variations significantly affect the performance or suitability of the material to perform as an adsorbent in different environments.

Generally, the larger the surface area of a porous material, the more effective it is in adsorption. Surface areas of porous materials are estimated by measuring the variation of the volume of nitrogen adsorbed by the material with partial pressure of nitrogen at a constant temperature. Analysis of the results by mathematical models originated by Brunauer, Emmett and Teller results in a value known as the BET surface area.

The distribution of pore sizes in a porous carbon material also affects its adsorption characteristics. In accordance with nomenclature used by those skilled in the art, pores in an adsorbent material are called “micropores” if their pore size is less than 2 nm (<2×10⁻⁹ m) in diameter, and “mesopores” if their pore size is in the range 2 to 50 nm. Pores are referred to as “macropores” if their pore size exceeds 50 nm. Pores having diameters greater than 500 nm do not usually contribute significantly to the adsorbency of porous materials. For practical purposes therefore, pores having diameters in the range 50 nm to 500 nm, more typically 50 to 300 nm or 50 to 200 nm, can be classified as macropores.

The relative volumes of micropores, mesopores and macropores in a porous material can be estimated using well-known nitrogen adsorption and mercury porosimetry techniques. Mercury porosimetry can be used to estimate the volume of macro- and mesopores; nitrogen adsorption can be used to estimate the volumes of micro- and mesopores, using the so-called BJH mathematical model. However, since the theoretical bases for the estimations are different, the values obtained by the two methods cannot be compared directly with each other.

Ion exchange resins (or ion exchange polymers) are also used as additives in filters. They comprise an insoluble support structure, which is normally in the form of organic polymer beads having a diameter of 1-2 mm. The material has a highly porous surface which provides sites that can trap ions, but only with the simultaneous release of other ions. There are many different types of ion exchange resins, some of which are particularly attractive for smoke filtration and therefore are incorporated into the filters of smoking articles. Chelating resins, such as Diaion® CR20, are capable of selectively removing metallic ions from cigarette smoke. However, their use in filters is limited by the fact that these ion exchange resins can have an unpleasant odour. Amberlite® CG-50 is a cross-linked methacrylic type of weakly acidic cation exchange resin powder which has a macroporous structure and a high concentration of carboxylic groups which serve as the ion exchange site of the resin.

Other particulate additive materials which are use in the filters of smoking articles include the following: an inorganic oxide, such as a silica, an alumina, a zirconium oxide, a titanium oxide, an iron oxide, or a cerium oxide. Other additives include aluminosilicates, such as zeolites, and sepiolite.

Some materials might be beneficial when incorporated into the filters of smoking articles, but they are physically not suited to such use. These materials include those that are structurally weak and are therefore prone to break up and form powders, which are undesirable in filters.

When more than one particulate additive is to be incorporated into a filter, this adds to the complexity of the manufacturing process and of the machinery required, leading to increased production costs. In particular, where the additive particles to be added have different particle sizes and/or different densities, they need to be separately added. This is because a mixture comprising such different materials held in a hopper for addition to the filter material during formation of a filter element will not remain as a uniform or homogenous mixture. Rather, settling and the like will occur over time, resulting in an uneven distribution of the two or more materials in the hopper and, consequently, inconsistent and uncontrolled addition of the materials to the filter materials. This is clearly unacceptable, as it will lead to filter elements having inconsistent and unpredictable characteristics, including filtration efficacy.

It is therefore an object of the present invention to provide an improved means for including at least two particulate additives into filters for smoking articles.

Agglomeration is the process by which particles of a smaller size bind together and form a larger particle. Where particles of two different starting materials are agglomerated, the resultant composite material includes both starting materials. Where the composite material is particulate in form, each particle of the composite material formed by agglomeration should include particles of both starting materials.

One of the main benefits of this technique is the possibility to combine multiple additives into a single composite material, thus making inclusion into a filter an easier process and reducing the need for expenditure on specialised mixing equipment. In addition, the agglomerated additive materials are easier to dose accurately having consistent particle size distributions and improved homogeneity. What is more, the agglomerated material may have various improved physical properties compared to the individual particles, such as increased strength and more uniform particle size and density.

However, whilst agglomeration may have benefits, many of the additives included in the filter elements of smoking articles have activity which is dependent upon contact of the smoke being drawn through the filter element with the additive particle surface. For example, volatiles are adsorbed onto the surface of many additives, such as activated carbon. Agglomeration of additive particles will obviously reduce the surface area of the particles which is available to contact the smoke. Thus, the incorporation of such additives into a filter in the form of an agglomerate would be expected to be accompanied by a loss of at least some of their filtration efficacy and/or other activity of additive.

WO 2008/031816 discloses composite material of high cohesive strength which is prepared by agglomerating at least one compound that is chosen from mineral oxides, aluminosilicates and active carbon, and a polymer. The agglomeration is controlled to provide agglomerates having a desired particle size (a mean particle size of at least 100 μm), pore volume and high cohesive strength.

### SUMMARY OF THE INVENTION

According to a first aspect of the present invention, a composite material is provided, wherein the composite material comprises particles of at least two different additive materials and a polymer binding said additive particles together in the composite material. Preferably, the agglomerates exhibit uniform density and a narrow particle size distribution.

According to a second aspect of the invention, a method of preparing a composite material of the first aspect is provided, wherein particles of the additive materials are mixed with the binding polymer to form a composite material.

According to a third aspect of the invention, a method of including at least two different additive materials in a filter material is provided, the method comprising the use of the composite material of the first aspect of the invention.

According to a fourth aspect of the invention, a use of the composite material of the first aspect of the invention is provided, to incorporate at least two different additive materials into a filter material.

According to a fifth aspect of the invention, a filter element for a smoking article is provided, comprising the composite material according to the first aspect of the invention.

According to a sixth aspect of the invention, a smoking article is provided, comprising the composite material according to the first aspect of the invention.

### DETAILED DESCRIPTION

The use of a composite material according to the present invention, which comprises two or more different additive materials, overcomes the abovementioned problems associated with adding two particulate additive materials separately.

The additives to be incorporated into the composite material according to the present invention are generally those that are incorporated into filters of smoking articles. They will generally afford the filter with beneficial properties, enhancing the filtration characteristics of the filter, improving the properties of the filtered smoke, or affording the smoking article as a whole some beneficial property. Frequently, the additives will be materials having adsorbent properties.

The use of more than one additive in a filter is attractive as this can allow the properties or characteristics of the filter to be adjusted and tailored to provide a particular combination of effects. For example, different adsorbent materials may have greater selectivity for different smoke constituents.

In addition, the inclusion of different additive materials can lead to the additives interacting and careful selection of additive combinations can produce beneficial effects, as one additive may be used to overcome disadvantages or problems associated with another. For example, some additives, such as certain ion exchange resins, have an unpleasant odour which limits their use in the filters of smoking articles. A combination of such a malodorous additive and an adsorbent, such as activated carbon or silica can overcome this problem as the adsorbent reduces the odour.

The formation of composite material comprising different additives can also allow one to control the physical properties of additive materials. As mentioned above, the composite material can be prepared to ensure a relatively uniform density and a narrow particle size distribution.

In one embodiment, the composite material of the invention has any suitable form, for instance particulate, fibrous, or a single monolithic entity. Preferably, however, the composite material is particulate. Suitable particle sizes are 100-1500 μm, or 150-1400 μm. In a preferred embodiment of the invention, the composite material is provided in the form of particles having an average particle size of at least 250 μm in order to avoid pressure drop problems which are associated with incorporating smaller particles in the filters of smoking articles

The preferred minimum pore volume and/or pore size of the composite material will depend upon the proposed purpose of the material when it is incorporated into the filter of a smoking article. For physisorption, the composite material according to the present invention preferably has a micropore volume of at least approximately 0.4 cm³/g. Where chemisorption is intended, the pore size is not so important. Carbon reduces smoke analytes predominantly via physisorption. Resins such as CR20 tend to reduce smoke analytes via chemisorption.

In addition, the agglomeration process is particularly useful when additives with poor strength are to be included. These relatively fragile particles can be agglomerated to form composite particles of sufficient strength to allow them to withstand transport, storage and processing, such as incorporation into the filter of a smoking article. This is especially the case when a fragile additive is agglomerated with a stronger additive material, such as an ion exchange resin, to form a composite material.

In one embodiment of the present invention, at least one of the additives included in the composite material is porous carbon. Activated carbon is a material commonly used in smoking article filters. It may be made from the carbonized form of many different organic materials, most commonly plant-based materials such as coconut shell.

Alternatively, other porous carbon materials may be used, such as carbonaceous dried gels. Such dried gels are porous, solid-state materials obtained from gels or sol-gels whose liquid component has been removed and replaced with a gas, which have then been pyrolyzed/carbonized. They can be classified according to the manner of drying and include carbon xerogels, aerogels and cryogels. Such gels may be obtained by the aqueous polycondensation of an aromatic alcohol (such as resorcinol) with an aldehyde (such as formaldehyde) in the presence of a catalyst (such as sodium carbonate).

In the case of activated carbon, the starting material can affect the strength of the activated product. Coconut shell is a popular starting material as it produces a relatively strong and robust activated carbon product which is not liable to fracture upon transport, storage and incorporation into a filter element. However, other abundant and cheap materials are not considered to be useful as a starting material for producing activated carbon. For example, tobacco stalk (commonly a waste product in the production of smoking articles) would be an economic starting material, but the resultant activated carbon is very friable. However, agglomerating particles of activated tobacco stalk carbon increases the strength of the material and makes its incorporation into a filter element possible. Other starting materials which can result in weak activated carbon which would benefit from agglomeration according to the present invention include vegetable sources, wood (such as, for example, oak chips) and bamboo.

Increasing the porosity of many adsorbent materials has the benefit of improving the filtration characteristics of the material, but frequently has the disadvantage that the structural integrity of the material is compromised so badly that the material is not suitable for inclusion in the filter elements of smoking articles. However, agglomeration can improve the structural integrity of the highly porous material, whilst allowing it to maintain its filtration characteristics.

In a preferred embodiment of the present invention, at least one of the additives used to form the composite material does not exhibit sufficient strength to be included in the form of individual particles, i.e. without agglomeration such as that according to the present invention.

In another embodiment of the present invention, at least one of the additives is an ion exchange resin. The ion exchange resin may be a chelating resin, such as Diaion® CR20. Alternatively or in addition, the ion exchange resin may be a cation exchange resin, such as Amberlite® CG-50. Diaion® CR20 from Mitsubishi Chemicals Corporation is particularly preferred, as it is considered to be the most effective resin for use in smoking article filters. It has amine surface functional groups and shows selectivity towards smoke aldehydes, such as formaldehyde, and towards HCN.

In another embodiment of the present invention, at least one of the additives is an inorganic oxide, such as a silica, an alumina, a zirconium oxide, a titanium oxide, an iron oxide, a cerium oxide, an aluminosilicate, such as a zeolite, or sepiolite.

In an embodiment of the invention, the polymer used in the composite materials and methods of the present invention may be selected from: cellulose and its derivatives, including cellulose acetate, cellulose sulphate, ethylcellulose, hydroxyethylcellulose, methylcellulose, the hydroxymethylcellulose, carboxymethyl cellulose; starch and its derivatives, including carboxymethyl starch, hydroxypropyl starch; alginates and their derivatives, including alginic acid, sodium alginate, potassium alginate, calcium alginate; polyethylene; agar; gums including gum arabic, gum tragacanth, guar gum, locust bean gum; polyvinyl alcohols and their derivatives, including polyvinyl acetates (optionally hydrolyzed), copolymers of polyvinyl acetates and vinyl esters of aliphatic carboxylic acids, and copolymers of ethylene and vinyl esters of saturated carboxylic acids aliphatic.

In particularly preferred embodiments of the invention, the polymer is cellulose or one of its derivatives (in particular, cellulose acetate or cellulose sulphate), polyethylene, gum arabic, or a polyvinyl alcohol.

In one particularly preferred embodiment of the present invention, the composite material comprises a combination of an ion exchange resin and an activated carbon. The ion exchange resin may, for example, be Diaion® CR20 or Amberlite® CG-50. Preferably, the polymer binding these additive materials is cellulose acetate.

When combining materials such as CR20 with activated carbon, the odour caused by the resin is completely eliminated.

Experimental

1) Carbon and Ion Exchange Composites

Three samples of composite additives were evaluated in a cigarette filter. The compositions of the three samples are the following: i) activated carbon and cellulose acetate (70:30); ii) activated carbon, CR20 (ion exchange resin) and cellulose acetate (35:35:30); and iii) CR20 and cellulose acetate (70:30).

85 mg of each of the three additives were incorporated into cavity filters (12 mm cellulose acetate mouth end/5 mm of filter additive/10 mm cellulose acetate rod end) attached to a tobacco rod containing a Virginia style tobacco of density 229 mg/cm³, length 56 mm, with an overall cigarette circumference 24.6 mm. No filter tip ventilation was used as this would have introduced another variable. 85 mg of additives were used in order to get a net weight of 60 mg of carbon or CR20 or carbon plus CR20 in the cavity.

As controls, (1) 60 mg of CR20; (2) 60 mg of activated carbon prior to grinding and granulating; and (3) an empty cavity of length 5mm were used in the filter. Cigarettes were conditioned at 22° C. and 60% Relative Humidity for 3 weeks prior to smoking. Smoking was performed under ISO conditions (i.e. one 35 ml volume puff of 2 second duration was taken every minute). Basic smoke chemistry results are shown in Table 1 below:

TABLE 1

| | Puff | NFDPM | Nicotine | Water | CO |
|---|---|---|---|---|---|
| | No. * | (mg/cig) | (mg/cig) | (mg/cig) | (mg/cig) |
| Empty Cavity | 7.0 | 10.5 | 1.00 | 2.0 | 9.6 |
| Carbon 60 mg | 7.2 | 9.9 | 1.01 | 1.7 | 10.1 |
| CR20 60 mg | 7.0 | 9.7 | 0.95 | 1.3 | 9.9 |
| Carbon/CR20 | 7.2 | 10.0 | 1.01 | 1.5 | 10.1 |
| 30 + 30 mg | | | | | |
| Carbon/CA 85 mg | 7.1 | 9.7 | 0.96 | 1.3 | 9.6 |
| CR20/CA 85 mg | 7.2 | 10.2 | 1.03 | 1.5 | 10.0 |
| Carbon/CR20 85 mg | 7.0 | 9.7 | 1.00 | 1.4 | 9.7 |

* Puff number per cigarette

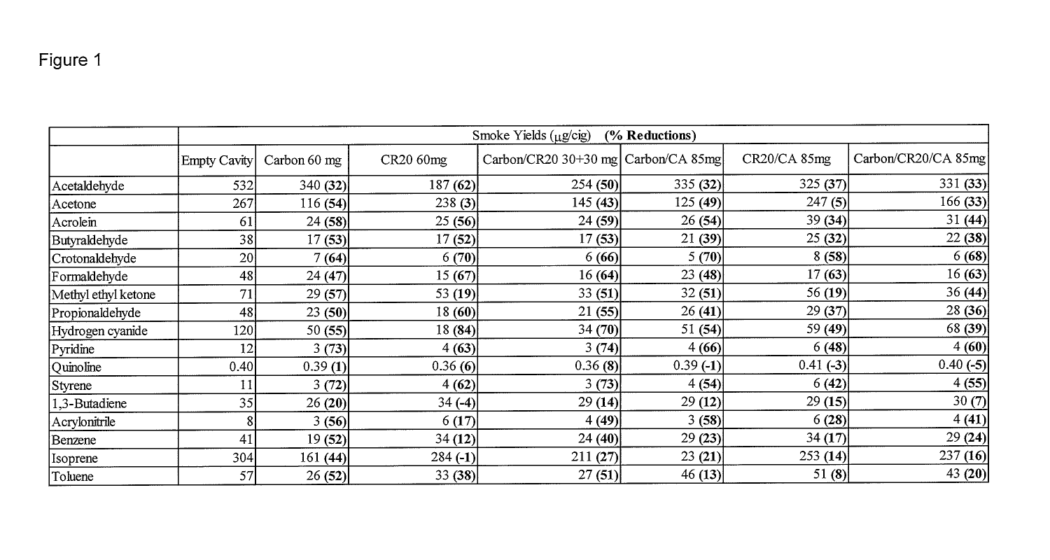

No significant differences in tar, CO and nicotine yields were observed. Smoke vapour phase compounds were measured and are shown in the table of FIG. 1. Yields were normalised to unit tar and the percentage reductions relative to the cigarette with empty cavity calculated. The percentage reductions relative to an empty cavity and normalised to unit tar are shown in brackets in the table.

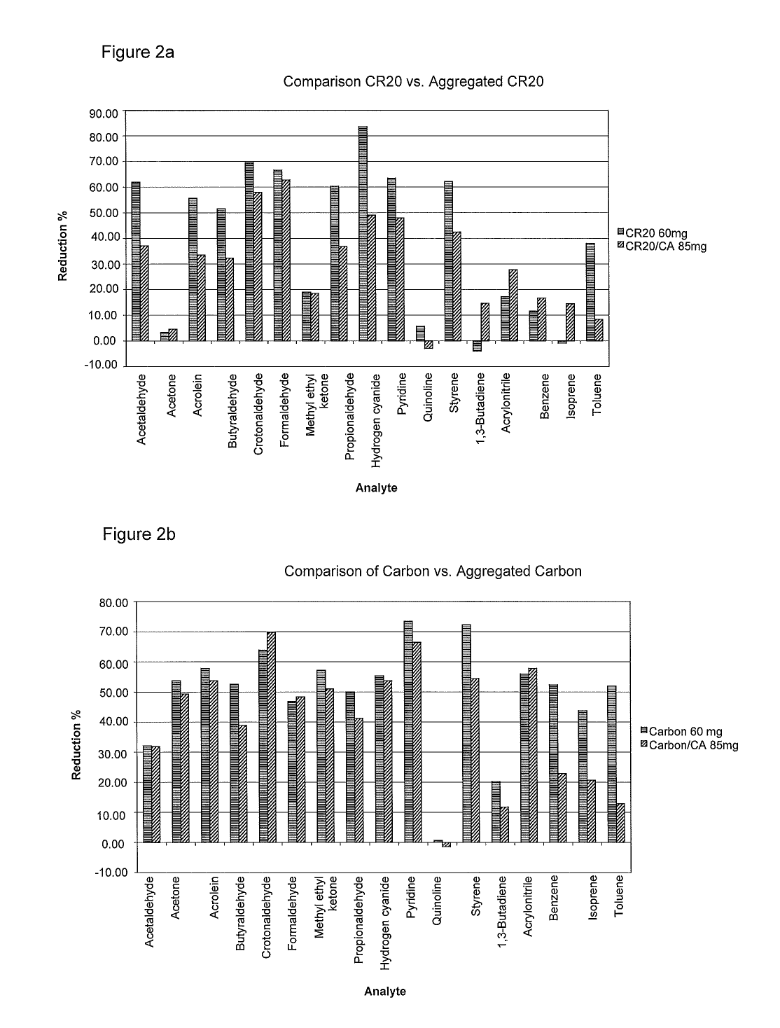

The graphs of FIGS. 2a to 2c show the effects of agglomeration for each type of material.

From the data above, the following observations can be made:
1) There is no significant difference in the selectivity for carbonyls and HCN when comparing the carbon with the agglomerated carbon; however the selected volatile reductions are lower for agglomerated carbon; and
2) The effects of agglomeration are larger for CR20. Agglomerated CR20 has a lower performance in all but formaldehyde and the selected volatiles reductions are considered to be experimental error.

Thus, it would appear that the agglomeration is affecting the CR20 ion exchange resin more than the carbon, probably due to the lower surface area of CR20 compared to carbon. In contrast, the agglomerated combination of carbon and CR20 performs relatively well across the board. However, the agglomeration of this combination of materials has eliminated odour problems associated with the ion exchange resin.

2) Composites Comprising Carbon from Tobacco Stalk and Stem

A sample of activated carbon with poor strength properties (derived from Virginia tobacco stalk and stem precursors) was agglomerated with cellulose acetate.

The activated carbon was ground to a fine powder and agglomerated with cellulose acetate. The resulting hard cylindrical shaped carbon composite granules consisted of a carbon:cellulose acetate ratio of approximately 3:1 and had a particle size distribution of 400-800 μm.

85 mg of the carbon composite was incorporated into a cavity filter design of an unventilated Virginia tobacco style reference cigarette. This weight of composite was used in order to achieve a net weight of 60 mg of carbon in the cavity. As controls, an empty cavity and cavity containing 60 mg of the base activated carbon were used.

Cigarettes were conditioned at 22° C. and 60% Relative Humidity for 3 weeks prior to smoking. Smoking was performed under ISO conditions (i.e. one 35 ml volume puff of 2 second duration was taken every minute). Basic smoke chemistry results are shown in Table 2 below.

TABLE 2

| | Filter | Puff | NFDPM | Nicotine | Water | CO |
|---|---|---|---|---|---|---|
| Cigarette | additive | No | (mg/cig) | (mg/cig) | (mg/cig) | (mg/cig) |
| Y126 1 | None | 6.8 | 10.6 | 0.94 | 1.7 | 10.1 |
| Y126 2 | Carbon | 6.6 | 9.4 | 0.87 | 1.2 | 9.8 |
| | Composite | | | | | |
| Y126 3 | Carbon | 7.1 | 9.2 | 0.82 | 1.5 | 10.8 |

Smoke vapour phase compounds were measured and are shown in Table 3. Yields were also normalised to unit tar and the percentage reductions relative to the cigarette with empty cavity calculated. These percentage reductions are shown in brackets in the table.

TABLE 3

| | Smoke Yields (μg/cig) (% Reductions) | | | | |
|---|---|---|---|---|---|
| | | Carbon | | | |
| Filter Additive | None | Composite | | Carbon | |
| Smoke Analyte | | | | | |
| Acetaldehyde | 581 | 491 | (5) | 491 | (3) |
| Acetone | 285 | 170 | (33) | 148 | (40) |
| Acrolein | 65 | 40 | (31) | 33 | (42) |
| Butyraldehyde | 37 | 20 | (39) | 16 | (51) |
| Crotonaldehyde | 20 | 6 | (65) | 2 | (88) |
| Formaldehyde | 46 | 28 | (32) | 17 | (57) |
| Methyl ethyl ketone | 70 | 32 | (48) | 20 | (68) |
| Propionaldehyde | 52 | 36 | (23) | 33 | (27) |
| HCN | 144 | 78 | (39) | 81 | (35) |
| 1,3-butadiene | 35 | 33 | (−7) | 26 | (13) |
| Actylonitrile | 9.7 | 5.2 | (40) | 3.3 | (61) |
| Benzene | 45 | 29 | (28) | 17 | (57) |
| Isoprene | 231 | 176 | (14) | 109 | (46) |

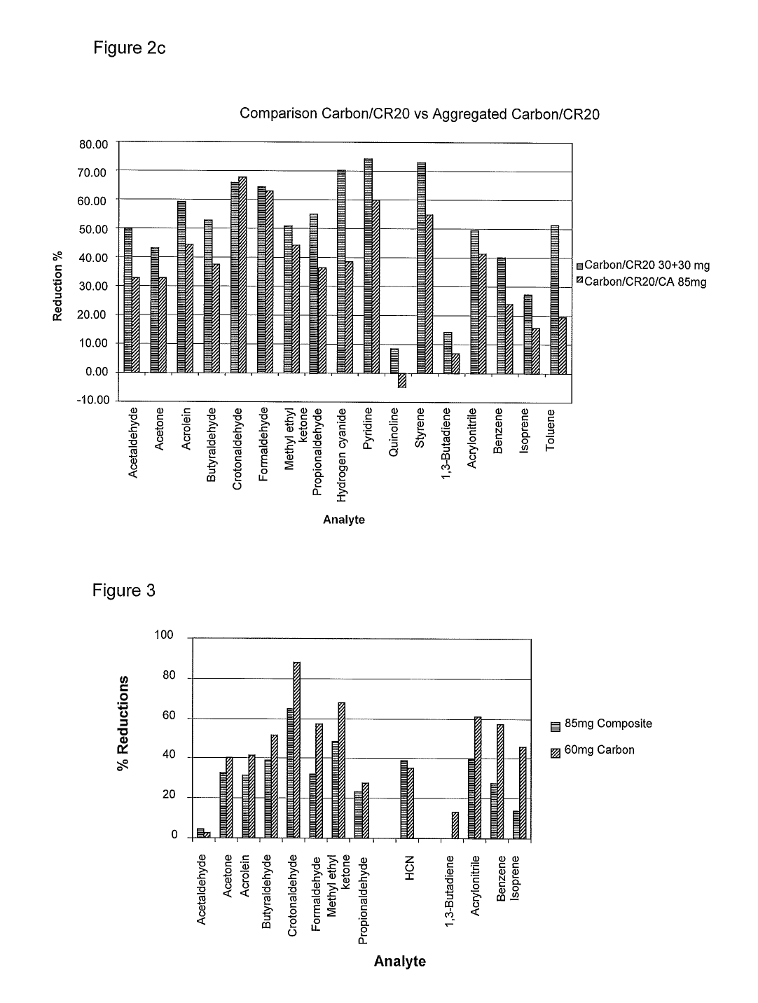

Percentage reductions are also shown graphically in FIG. 3. It can be seen that, with the exception of HCN, the cellulose acetate has caused small reductions in the carbon performance when evaluated in a cigarette filter. The reductions in performance are smallest for the smoke carbonyls and greatest for the selected volatiles acrylonitrile, benzene and isoprene. Reductions in 1,3-butadiene were small for both samples. These observations are similar to those using the activated coconut carbon sample.

From this experimental work it can be concluded that agglomeration of a particulate additive material with cellulose acetate (CA) is useful for improving filter additive strength characteristics, giving a narrow particle size distribution and combining additives into one material with no significant loss of performance. From a sensorial point of view, there are no differences in the smoking attributes measured therefore there are no significant differences between the control and the test products.

All publications mentioned in the above specification are herein incorporated by reference. Various modifications and variations of the described methods and system of the present invention will be apparent to those skilled in the art without departing from the scope of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. An agglomerated composite material comprising particles of an ion exchange resin as a first additive material, particles of at least one second additive material and a polymer binding said first and at least one second additive particles together in the composite material.

2. The material as claimed in claim 1, wherein the first and second additive materials have at least one of different densities and different particle sizes.

3. The material as claimed in claim 1, wherein the at least one second additive material is selected from at least one of: porous carbonation materials; inorganic oxides; and aluminosilicates.

4. The material as claimed in claim 1, wherein the polymer is at least one of: cellulose or a derivative thereof; starch or a derivative thereof; an alginate or derivative thereof; polyethylene; agar; a gum; and a polyvinyl alcohol or derivative thereof.

5. The material as claimed in claim 1 wherein the polymer is cellulose acetate.

6. The material as claimed in claim 1, wherein the composite material has an average particle size of at least 250 μm.

7. The method of preparing a composite material, said composite material comprising particles of an ion exchange resin as a first additive material, particles of at least one second additive material and a polymer binding said first and at least one second additive particles together in the composite material, wherein particles of the additive materials are mixed with the binding polymer to form the composite material.

8-9. (canceled)

10. A filter element for a smoking article, comprising a composite material, said composite material comprising particles of an ion exchange resin as a first additive material, particles of at least one second additive material and a polymer binding said first and at least one second additive particles together in the composite material.

11. A smoking article, comprising composite material, said composite material comprising particles of an ion exchange resin as a first additive material, particles of at least one second additive material and a polymer binding said first and at least one second additive particles together in the composite material.
